(19) United States
(12) Patent Application Publication
(10) Pub. No.: US 2020/0274130 A1
(43) Pub. Date: Aug. 27, 2020

(54) Wire-Bundle Receiving Bracket and Battery Module

(71) Applicant: Contemporary Amperex Technology Co., Limited, Ningde (CN)

(72) Inventor: Yuchao Chen, Ningde (CN)

(21) Appl. No.: 16/538,567

(22) Filed: Aug. 12, 2019

(30) Foreign Application Priority Data
Feb. 26, 2019 (CN) 201920240599.4

(51) Int. Cl. H01M 2/20; H01M 2/22; H01M 2/10; H01M 10/42; H01M 10/48

(52) U.S. Cl. CPC H01M 2/206; H01M 2/22; H01M 10/482; H01M 10/425; H01M 2/1077

(57) ABSTRACT

The present disclosure provides a wire-bundle receiving bracket and a battery module. The wire-bundle receiving bracket is configured to fix a wire-bundle of the battery module and includes: a wire-bundle receiving slot including a first side wall and a second side wall opposite to the first side wall; a clasp part including a cover plate for covering the wire-bundle receiving slot, as well as a curved portion and a buckling portion that are disposed at two ends of the cover plate. The curved portion is connected to the first side wall, and the buckling portion is buckled on the second side wall. The present disclosure can facilitate the installing and receiving of the wire-bundle, thereby improving reliability of the received wire-bundle.

### CROSS-REFERENCE TO RELATED APPLICATIONS

The present application claims priority to Chinese Patent Application No. 201920240599.4, filed on Feb. 26, 2019, the content of which is incorporated herein by reference in its entirety.

### TECHNICAL FIELD

The present disclosure relates to the technical field of energy storage devices, and in particular, to a wire-bundle receiving bracket and a battery module.

### BACKGROUND

A battery module includes a plurality of batteries. In order to acquire data about characteristics such as voltage and temperature of each battery, a sampling wire-bundle is provided in the battery module. Since there is a large number of sampling wire-bundles provided in the battery module and a potential difference between the wire-bundles is relatively high, the improper installation and fixation of the wire-bundle may cause abnormal abrasion of an insulation layer of the wire-bundle, and further cause electric leakage and short circuit, which may further result in more electrical failures or even a fire on the battery module. In such a case, personal safety and property safety are in danger.

At present, the wire-bundle is installed and fixed mainly in two ways. The first way is strapping, which is inconvenient to operate and may result in a lower productivity of the battery module. The second way is snap-in, which may easily cause a detachment of the wire-bundle from a wire slot due to the presence of an opening in the wire slot and thus reduces the reliability of the battery module.

### SUMMARY

The present disclosure provides a wire-bundle receiving bracket and a battery module to facilitate installing and receiving the wire-bundle, thereby improving reliability of receiving the wire-bundle.

In one aspect, the present disclosure provides a wire-bundle receiving bracket for receiving a wire-bundle of a battery module, including a wire-bundle receiving slot comprising a first side wall and a second side wall opposite to the first side wall; and a clasp part comprising a cover plate for covering the wire-bundle receiving slot, and a curved portion and a buckling portion that are disposed at two ends of the cover plate, wherein the curved portion is connected to the first side wall, and the buckling portion is buckled on the second side wall.

In an embodiment, the curved portion has an elastic arcuate structure.

In an embodiment, the curved portion has a smaller thickness than the cover plate.

In an embodiment, an avoiding slot is formed between an inner side of the curved portion and the cover plate.

In an embodiment, a protrusion is provided at an inner side of the cover plate to tightly press the wire-bundle.

In an embodiment, a groove is provided in a middle portion of the protrusion, and the groove extends along a length direction of the wire-bundle receiving slot and extends over a whole length of the protrusion.

In an embodiment, the buckling portion comprises an extending section and a first buckling section, the extending section extends in a direction facing towards an inner side of the cover plate, and the first buckling section is disposed at an end of the extending section facing away from the cover plate, and a second buckling section for matching the first buckling section is provided on the second side wall.

In an embodiment, the wire-bundle receiving slot and the clasp part are formed into one piece by injection molding.

In an embodiment, the wire-bundle receiving bracket further includes a baffle. The baffle includes a first end fixedly connected to the first side wall or the second side wall, and a second end provided with a mounting notch.

In a second aspect, the disclosure provides a battery module, including the wire-bundle receiving bracket described in the first aspect.

The technical solutions provided by the present disclosure can achieve the following beneficial effects.

The wire-bundle receiving bracket provided by the present disclosure includes a wire-bundle receiving slot and a clasp part. The wire-bundle receiving slot is provided with an opening for facilitating installation of the wire-bundle. The opening of the wire-bundle receiving slot is covered by clasp part, so that the wire-bundle is received in the wire-bundle receiving slot. The operation is convenient, and the wire-bundle is reliably received. An end of the clasp part is provided with a curved portion, and the curved portion is connected to the first side wall of the wire-bundle receiving slot, so that the clasp part can flip to open and close the opening of the receiving slot. Another end of the clasp part is provided with a buckling portion, and the buckling portion is buckled on the second side wall of the wire-bundle receiving slot to close the opening of the wire-bundle receiving slot by the clasp part during use, thereby prevent the wire-bundle from detaching from the wire-bundle receiving slot.

It should be understood that the foregoing general description and the following detailed description are merely illustrative and are not intended to limit the present disclosure.

### BRIEF DESCRIPTION OF DRAWINGS

FIG. 1 is a structural schematic diagram of a battery module according to an embodiment of the present disclosure;

FIG. 2 is a top view of the battery module shown in FIG. 1;

FIG. 3 is a structural schematic diagram of a wire-bundle receiving bracket according to an embodiment of the present disclosure;

FIG. 4 is a partially enlarged view of the wire-bundle receiving bracket shown in FIG. 3;

FIG. 5 is a structural cross-sectional view of a clasp part in a closed state according to an embodiment of the present disclosure; and

FIG. 6 is a structural cross-sectional view of a clasp part in an open state according to an embodiment of the present disclosure.

### REFERENCE NUMERALS

1 case;
2 supporting plate;
20 connection sheet;
3 wire-bundle receiving bracket;
30 wire-bundle receiving slot;
300 first side wall;
302 second side wall;
302a second buckling section;
304 bottom wall;
32 clasp part;
320 cover plate;
322 curved portion;
322a avoiding slot;
324 buckling portion;
324a extending section;
324b first buckling section;
326 protrusion;
326a groove;
326b locking foot;
34 baffle;
340 first end;
342 second end;
344 mounting notch; and
4 wire-bundle.

The drawings herein are incorporated into and constitute a part of the present specification, illustrate embodiments of the present disclosure and explain principles of the present disclosure together with the specification.

### DETAILED DESCRIPTION OF EMBODIMENTS

In order to make the purpose, technical solutions, and advantages of the embodiments of the present disclosure be understandable, the technical solutions in the embodiments of the present disclosure are described in the following with reference to the accompanying drawings. It should be understood that the described embodiments are merely exemplary embodiments of the present disclosure, which shall not be interpreted as providing limitations to the present disclosure.

In the description of the present disclosure, the terms “first” and “second” are used merely for a purpose of description, which shall not be construed as indicating or implying relative importance, unless otherwise stated or indicated. The term “plurality” means two or more, unless otherwise stated or indicated. The terms “connect”, “fix” and the like shall be construed in a broad sense. For example, “connection” may be fixed connection, detachable connection, integral connection, or electrical connection, and the “connection” may be either direct connection or indirect connection via an intermediate element. For those skilled in the art, the specific meanings of the above terms in the present disclosure can be understood according to specific situations.

It should be understood that in the description of the present disclosure, the terms such as “upper”, “lower” and the like are used to indicate positions shown in the drawing, instead of being construed as limitations of the embodiment of the present disclosure. In addition, when an element is described as being “above” or “under” another element in the context, it should be understood that the element can be directly or via an intermediate element located “above” or “under” another element.

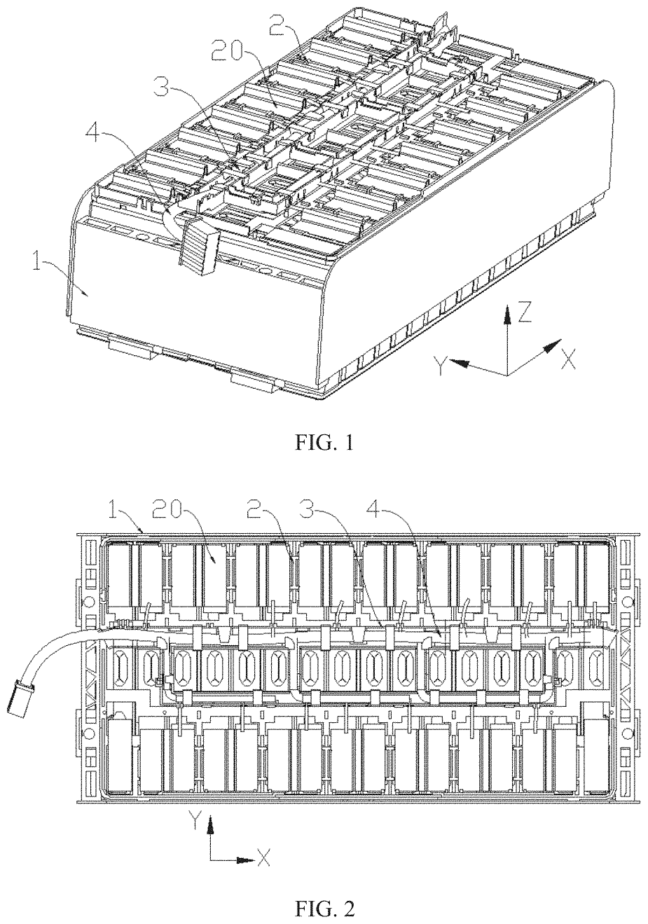

As shown in FIG. 1 and FIG. 2, an embodiment of the present disclosure provides a battery module, including a case 1, a supporting plate 2 and a wire-bundle receiving bracket 3. The case 1 receives a plurality of batteries (not shown). The supporting plate 2 is disposed at the top of the case 1, and the supporting plate 2 supports connection sheet 20. Adjacent batteries are connected to each other through the connection sheet 20, thereby connecting the plurality of batteries in series and/or in parallel. The wire-bundle receiving bracket 3 is connected to the supporting plate 2 for mounting and receiving the wire-bundle 4. Specifically, the wire-bundle receiving bracket 3 can be buckled on the supporting plate 2.

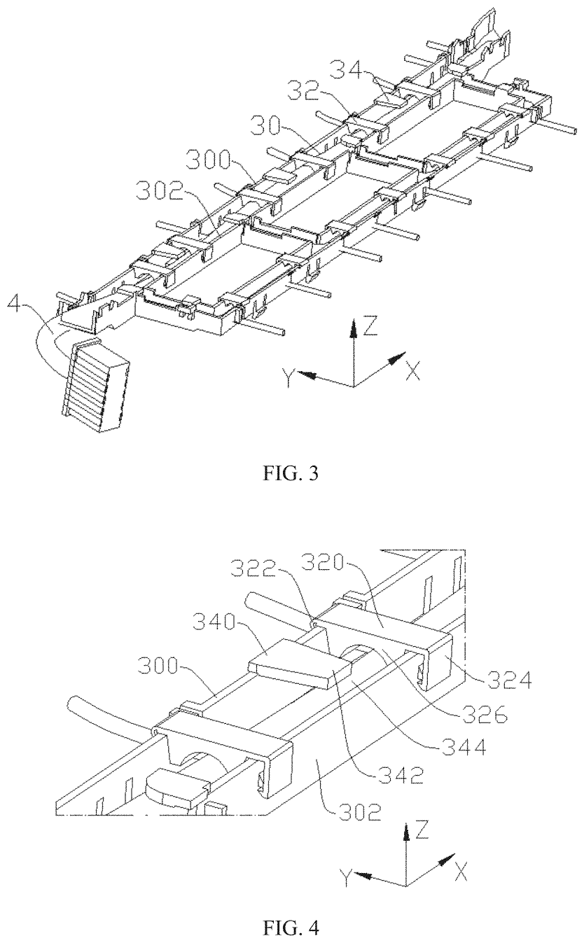

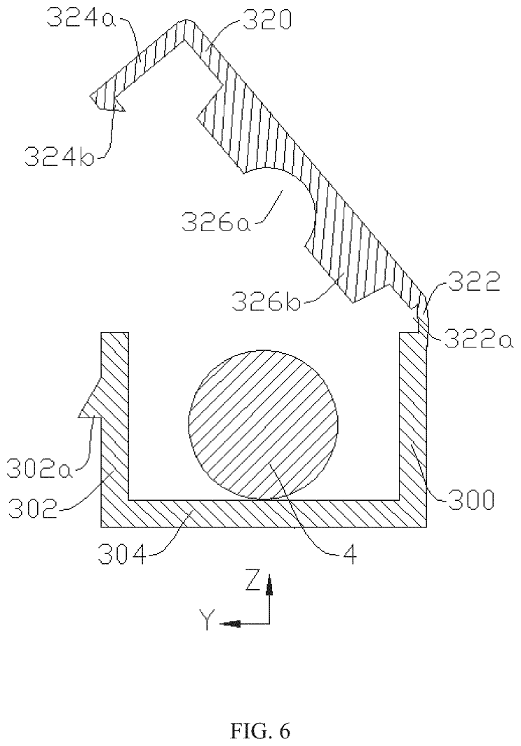

The embodiment shown in FIG. 3 to FIG. 6 provides a wire-bundle receiving bracket 3. The wire-bundle receiving bracket 3 includes a wire-bundle receiving slot 30 and a clasp part 32, and the wire-bundle 4 is received in the wire-bundle receiving slot 30 by the clasp part 32. The clasp part 32 closes an opening of the wire-bundle receiving slot 30 when the clasp part 32 is in a closed state, and the clasp part 32 opens the opening of the wire-bundle receiving slot 30 when the clasp part 32 is in an open state. The wire-bundle 4 can be installed easily and received securely. With a proper matching between the clasp part 32 and the wire-bundle 4, the wire-bundle 4 can be fixed in the wire-bundle receiving slot 30. The wire-bundle receiving slot 30 includes a first side wall 300 and a second side wall 302 opposite to the first side wall 300. The first side wall 300 and the second side wall 302 are connected at bottom through a bottom wall 304. The opening of the wire-bundle receiving slot 30 is provided at top for facilitating installation of the wire-bundle 4. The clasp part 32 is configured to cover the opening of the wire-bundle receiving slot 30, so as to secure the wire-bundle 4 in the wire-bundle receiving slot 30. In this way, the wire-bundle 4 is prevented from detaching from the wire-bundle receiving slot 30. For example, the clasp part 32 includes a cover plate 320, as well as a curved portion 322 and a buckling portion 324 that are respectively disposed at two ends of the cover plate 320. The curved portion 322 is connected to the first side wall 300, so that the clasp part 32 can flip through the curved portion 322 to open or close the opening of the wire-bundle receiving slot 30 (an area of the opening corresponding to the clasp part 32). The buckling portion 324 is buckled on the second side wall 302, such that the opening of the wire-bundle receiving slot 30 can be closed by the clasp part 32 during use, preventing the detachment of the wire-bundle 4. For example, the wire-bundle receiving bracket 3 can include a plurality of clasp parts 32 sequentially arranged along a length direction of the wire-bundle receiving slot 30, i.e., a direction X shown in FIG. 1 and FIG. 2, in order to provide multiple fixing points for the wire-bundle 4 and further improve the fixation reliability of the wire-bundle 4. For example, two adjacent clasp parts 32 are spaced apart from each other with a distance, and the distance between adjacent clasp parts 32 can be determined according to softness and movable space of the wire-bundle 4. Two adjacent clasp parts 32 can fix a segment of the wire-bundle 4, thereby reducing the number of required clasp parts 32 and reducing operation complexity.

In an embodiment, the wire-bundle receiving slot 30 and the clasp part 32 are made of a same material, and the wire-bundle receiving slot 30 and the clasp part 32 are formed into one piece by injection molding, which is simple and can produce a reliable connection.

The curved portion 322 can be any structure allowing the clasp part 32 to flip, such as a hinge structure or a bendable structure having elasticity.

In an embodiment, when the clasp part 32 is in the closed state, the curved portion 322 is an elastic arcuate structure. When the clasp part 32 opens the opening of the wire-bundle receiving slot 30 by flipping, the curved portion 322 is stretched into a linear structure or an approximately linear structure. When the clasp part 32 closes the opening of the wire-bundle receiving slot 30 by flipping, the curved portion 322 is deformed by bending and forms a rebound force. Under the effect of the rebound force, the clasp part 32 is tightly connected to the wire-bundle receiving slot 30 through the buckling portion 324, thereby preventing a vibration of the clasp part 32 from affecting the fixation reliability of the wire-bundle 4.

Further, the curved portion 322 has a smaller thickness than the cover plate 320, and thus the curved portion 322 and the cover plate 320 have different elasticity. In other words, the curved portion 322 has a smaller thickness and a greater elasticity, and thus is likely to be bent and deformed to flip the clasp part 32; and the cover plate 320 has a greater thickness and a lower elasticity, which inhibits the bending and deformation, such that the clasp part 32 is capable of closing the opening of the wire-bundle receiving slot 30.

For example, when the thickness of the curved portion 322 is smaller than the thickness of the cover plate 320, an avoiding slot 322a is formed between an inner side of the curved portion 322 and the cover plate 320. On the one hand, the avoiding slot 322a is located at the inner side the curved portion 322, and thus an outer portion of the wire-bundle receiving bracket 3 maintains flat when the clasp part 32 is in the closed state, such that sharp portions are prevented from scratching the operator or other components; on the other hand, since the inner side of the curved portion 322 is not completely fitted during bending, a gap is formed between the cover plate 320 and the top of the wire-bundle receiving slot 30, with the avoiding slot 322a, the cover plate 320 can protrude from the inner side of the curved portion 322, thereby reducing the gap between the cover plate 320 and the top of the wire-bundle receiving slot 30, reducing the movable space of the clasp part 32, and increasing the fixation reliability of the wire-bundle 4.

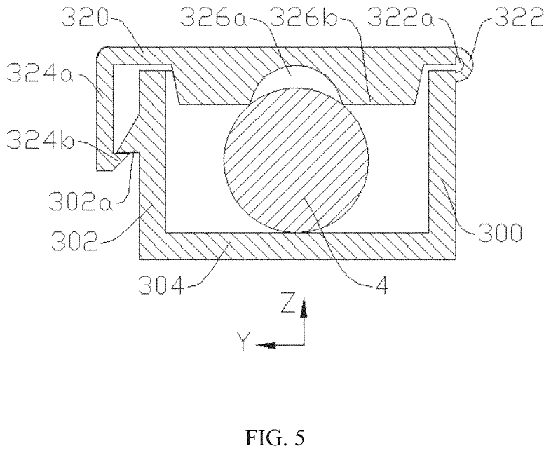

Further, the inner side of the cover plate 320 (a side of the cover plate 320 facing towards the wire-bundle receiving slot 30, i.e., an opposite direction to direction Z shown in FIG. 5) is provided with a protrusion 326 to press against the wire-bundle 4, so as to prevent the movement of the wire-bundle 4 in the wire-bundle receiving slot 30, which can cause breakage of the wire-bundle 4 and electric leakage. For example, a slot width of the wire-bundle receiving slot 30, i.e., a distance between an inner side of the first side wall 300 and an inner side of the second side wall 302, is larger than an outer diameter of the wire-bundle 4; and a slot depth of the wire-bundle receiving slot 30, i.e., a distance between the top of the wire-bundle receiving slot 30 and a bottom wall 304 of the wire-bundle receiving slot 30, is larger than the outer diameter of the wire-bundle 4, so that the wire-bundle receiving slot 30 can be easily installed into the wire-bundle receiving slot 30. For example, both the slot width and the slot depth are larger than the outer diameter by 1 to 3 mm. When the difference between the slot width (or slot depth) and the outer diameter is smaller than 1 mm, it is difficult to perform assembly; and when the difference is larger than 3 mm, the wire-bundle receiving slot 30 occupies a relatively large space. When the clasp part 32 is in the closed state, the distance between the protrusion 326 and the bottom wall 304 should be smaller than the outer diameter of the wire-bundle 4, so as to apply a pressing force between the protrusion 326 and the wire-bundle 4.

In an embodiment, one or more protrusions 326 can be provided along a width direction of the wire-bundle receiving slot 30. When more than one protrusions 326 are provided, each protrusion 326 has a height gradually increasing along a direction from the middle portion to both ends of the cover plate 320, thereby maintaining each protrusion 326 in contact with the wire-bundle 4.

In an embodiment, a side of the protrusion 326 facing away from the cover plate 320 can have either a planar surface or a concave surface. The concave surface is preferable, which increases a contact area between the protrusion 326 and the wire-bundle 4, thereby increasing the fixation reliability of the wire-bundle 4. The side of the protrusion 326 may be provided with a slip-proof notch for preventing the wire-bundle 4 from slipping.

Further, when only one protrusion 326 is provided along the width direction of the wire-bundle receiving slot 30, the middle portion of the protrusion 326 is provided with a groove 326a. The groove 326a extends over the length of the wire-bundle receiving slot 30 (along the direction X shown in the figures) and passes through the protrusion 326. The presence of the groove 326a produces two locking feet 326b that are separated on the protrusion 326. The two locking feet 326b fix the wire-bundle 4 respectively at two sides of the wire-bundle 4. In this way, the wire-bundle 4 is prevented from moving laterally and detaching from the protrusion 326, and the contact area between the protrusion 326 and the wire-bundle 4 is also increased, thereby enhancing the fixation reliability.

The groove 326a can have a cross-section of any shape such as an arcuate cross-section, a polyline cross-section, etc., and in the present embodiment, merely the arcuate cross-section is described in details as an example. For example, an inner diameter of the groove 326a is not larger than the outer diameter of the wire-bundle 4, so that the protrusion 326 can tightly press against the wire-bundle 4 with the locking feet 326b. It should be understood that the inner diameter of the groove 326a can also be larger than the outer diameter of the wire-bundle 4, in which the protrusion 326 tightly presses against the wire-bundle 4 through the bottom of the groove 326a.

Further, the above-mentioned buckling portion 324 includes an extending section 324a and a first buckling section 324b, and the second side wall 302 is provided with a second buckling section 302a. The first buckling section 324b matches and is buckled on the second buckling section 302a. The extending section 324a extends in a direction facing towards the inner side of the cover plate 320 (the side of the cover plate 320 facing towards the wire-bundle receiving slot 30, i.e., the opposite direction of the direction Z shown in FIG. 5). The first buckling section 324b is arranged at an inner side of an end of the extending section 324a facing away from the cover plate 320, thereby enlarging a covering area of the clasp part 32 on the wire-bundle receiving slot 30, and thus increasing the connection reliability.

The first buckling section 324b and the second buckling section 302a can be any structures that match each other, such as engaged protrusion and groove, or two connected protrusions. For example, the first buckling section 324b and the second buckling section 302a are two protrusions that are connected to each other, so as to avoid a groove structure in the buckling portion 324 or in the second side wall 302 that may weaken their strength.

When the first buckling section 324b and the second buckling section 302a are protrusions, a side of the first buckling section 324b facing towards the cover plate 320 is in contact with a side of the second buckling section facing away from the cover plate 320. The side of the first buckling section 324b facing away from the cover plate 320 and/or the side of the second buckling section 302a facing towards the cover plate 320 can be provided with a buckling guidance surface, for example, an oblique surface or an arcuate surface, in order to facilitate the buckling between the first buckling section 324b and the second buckling section 302a and reduce the force required for buckling the clasp part 32.

In an embodiment, a length of the extending section 324a is approximately a half of the slot depth of the wire-bundle receiving slot 30. In this way, the fixation thereof is reliable and difficult to loosen. When the length of the extending section 324a is larger than the half of the slot depth of the wire-bundle receiving slot 30, the extending section 324a has a relatively high elasticity and thus is likely to be detached. When the length of the extending section 324a is smaller than the half of the slot depth of the wire-bundle receiving slot 30, the extending section 324a has a relatively low elasticity and thus a brittle fracture of the extending section 324a may occur during the buckling.

Further, the wire-bundle receiving bracket provided by the present disclosure further includes a baffle 34. The baffle 34 has two opposite ends, i.e., a first end 340 and a second end 342. The first end 340 is fixed to the first side wall 300 or the second side wall 302, and the second end 342 is provided with a mounting notch 344. The wire-bundle 4 can be installed into the wire-bundle receiving slot 30 through the mounting notch 344, and the baffle 34 can pre-fix the wire-bundle 4, thereby preventing the wire-bundle 4 from detaching from the wire-bundle receiving slot 30 during the buckling process of the clasp part 32.

In an embodiment, the baffle 34 can be disposed between two adjacent clasp parts 32, so as to prolong the possible distance between adjacent clasp parts 32, and thus further reducing the number of the clasp parts 32.

The above-described embodiments are merely preferred embodiments of the present disclosure and are not intended to limit the present disclosure. Various changes and variations can be made to the present disclosure by those skilled in the art. However, any modifications, equivalent substitutions and improvements made within the principle of the present disclosure shall fall into the protection scope of the present disclosure.

What is claimed is:

1. A wire-bundle receiving bracket for receiving a wire-bundle of a battery module, comprising:
a wire-bundle receiving slot comprising a first side wall and a second side wall opposite to the first side wall; and
a clasp part comprising a cover plate for covering the wire-bundle receiving slot, and a curved portion and a buckling portion that are disposed at two ends of the cover plate, wherein the curved portion is connected to the first side wall, and the buckling portion is buckled on the second side wall.

2. The wire-bundle receiving bracket according to claim 1, wherein the curved portion comprises an elastic arcuate structure.

3. The wire-bundle receiving bracket according to claim 1, wherein the curved portion comprises a smaller thickness than the cover plate.

4. The wire-bundle receiving bracket according to claim 3, wherein an avoiding slot is formed between an inner side of the curved portion and the cover plate.

5. The wire-bundle receiving bracket according to claim 1, wherein a protrusion is provided at an inner side of the cover plate to tightly press the wire-bundle.

6. The wire-bundle receiving bracket according to claim 5, wherein a groove is provided in a middle portion of the protrusion, and the groove extends along a length direction of the wire-bundle receiving slot and extends over a whole length of the protrusion.

7. The wire-bundle receiving bracket according to claim 1, wherein the buckling portion comprises an extending section and a first buckling section,
the extending section extends in a direction facing towards an inner side of the cover plate, and the first buckling section is disposed at an end of the extending section facing away from the cover plate, and
wherein a second buckling section for matching the first buckling section is provided on the second side wall.

8. The wire-bundle receiving bracket according to claim 1, wherein the wire-bundle receiving slot and the clasp part are formed into one piece by injection molding.

9. The wire-bundle receiving bracket according to claim 1, further comprising a baffle, wherein the baffle comprises a first end fixedly connected to the first side wall or the second side wall, and a second end provided with a mounting notch.

10. A battery module, comprising the wire-bundle receiving bracket according to claim 1.
